(19) United States
(12) Patent Application Publication
(10) Pub. No.: US 2010/0158255 A1
(43) Pub. Date: Jun. 24, 2010

(54) METHOD AND SYSTEM FOR PROTECTING BROADCASTING PROGRAM

(75) Inventors: Won-Sik CHEONG, Daejon (KR); Hyon-Gon CHOO, Daejon (KR); Jooyoung LEE, Seoul (KR); Sangwoo AHN, Daejon (KR); Sang-Kwon SHIN, Daejon (KR); Moon-Kyun OH, Daejon (KR); Jeho NAM, Seoul (KR); Jin-Woo HONG, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/555,637

(22) Filed: Sep. 8, 2009

(30) Foreign Application Priority Data
Dec. 19, 2008 (KR) 10-2008-0130703

(51) Int. Cl. H04L 9/08; H04L 9/00

(52) U.S. Cl. 380/286; 380/44

(57) ABSTRACT

Disclosed is a method and system for storing encryption key information and package key information for decrypting encrypted broadcasting programs to store broadcasting programs. The method for protecting broadcasting programs includes generating and storing information about a first encryption key for encrypting broadcasting programs, and generating package key information by encrypting the first encryption key using a second encryption key.

### CROSS-REFERENCE TO RELATED APPLICATIONS

The present invention claims priority of Korean Patent Application No. 10-2008-0130703, filed on Dec. 19, 2008, which is incorporated herein by reference.

### BACKGROUND OF THE INVENTION

1. Field of the Invention

The present invention relates to protection of a broadcasting program; and, more particularly, to a method and system for storing encryption key information and package key information for decrypting encrypted broadcasting programs to store broadcasting programs.

2. Description of Related Art

Lately, broadcasting programs have been illegally distributed. In general, the broadcasting programs are illegally distributed through peer to peer (P2P) websites or web storage service providers such as Web-hard. The illegally distributed broadcasting program can be reproduced without a corresponding right. This feature of broadcasting program makes it difficult to be protected from illegal distribution. Therefore, it is required to develop a method for effectively protecting a broadcasting program from illegal distribution.

In order to prevent the illegal distribution, digital rights management (DRM) was applied to the broadcasting program. The DRM includes an encryption technology that enables only a user or a terminal having a right to reproduce a corresponding broadcasting program.

For example, when a terminal receives and stores a broadcasting program, the terminal must be restricted to make illegal distribution of the broadcasting program although the terminal has a use right of recording, copying, and replaying the broadcasting program within a personal use/duplication range.

In order to restrict the illegal distribution, as a related art, encryption information was shared only with users or terminals that have a use right of a corresponding broadcasting program after encrypting and storing the corresponding broadcasting program. Accordingly, only the users or the terminals having the use right are enabled to decrypt the corresponding broadcasting program. In this way, users or terminals without a proper use right of a corresponding broadcasting program are restricted to decrypt the corresponding program since they do not have the encryption information.

Advanced Television Systems Committee (ATSC) standard includes a redistribution control descriptor (RC descriptor) that defines transmission and insertion of redistribution restriction information in a broadcasting program in order to prevent illegal distribution of a broadcasting program. Table 1 shows a structure of a RC descriptor.

TABLE 1

| Syntax | No. of Bits | Format |
|---|---|---|
| rc_descriptor( ){ | | |
| descriptor_tag | 8 | 0xAA |
| descriptor_length | 8 | uimsbf |
| for(i=0;i<descriptor_length;i++){ | | |
| rc_information( ) | 8 | uimsbf |
| } | | |
| } | | |

However, the ATSC standard does not define rc_information( ) for protecting a broadcasting program.

In order to include information about controlling redistribution of a broadcasting program and information related to copyright in rc_information ( ) of the RC descriptor, program protection information (PPI) was defined. The PPI includes redistribution controlling information, redistribution allowance range information such as “no redistribution permitted”, “restricted redistribution permitted” or “full redistribution permitted”, and information about restriction details.

Accordingly, it is necessary to have a scheme for technically protecting a broadcasting program set with “no redistribution” and “restricted redistribution permitted”. Such a technical protection scheme generally includes an encryption scheme for a broadcasting program.

The ATSC standard and the PPI standard do not introduce a method for storing necessary information about an encrypted broadcasting program and about decrypting encrypted broadcasting program.

As a standard for defining storing the encrypted broadcasting program, ISO Base Media File Format (ISO/IEC 14496-12; ISO base media file format) was introduced. The ISO Base Media File Format defines a technology of storing a received broadcasting program in a format of MPEG-2 TS. The ISO Base Media File Format defines information about whether stored MPEG-2 TS is encrypted or not, a previous format before encrypting a corresponding broadcasting program, necessary information for protecting a broadcasting program based on MPEG intellectual property management and protection (IPMP), a scheme type used for protecting a broadcasting program, and scheme information used for protecting a broadcasting program.

However, the IOS Base Media File Format does not define a method for storing scheme information according to a scheme type although the IOS Base Media File Format defines a container box for storing the scheme type and the scheme information.

That is, there is a demand for developing a method and apparatus for storing an encrypted broadcasting program and necessary information for decrypting the encrypted broadcasting program as a technology for protecting a broadcasting program.

### SUMMARY OF THE INVENTION

An embodiment of the present invention is directed to providing a method and apparatus for storing encryption key information and package key information with or separately from an encrypted broadcasting program in order to enable a user or a terminal having a reproduction right to decrypt an encrypted and stored broadcasting program.

In accordance with an aspect of the present invention, there is provided a method for protecting a broadcasting program, including generating and storing information about a first encryption key for encrypted the broadcasting program, and generating package key information by encrypted the first encryption key using a second encryption key.

In accordance with another aspect of the present invention, there is provided a system for protecting a broadcasting program, including a first encryption key generator configured to generate a first encryption key for encrypted the broadcasting program, a broadcasting program encryptor configured to generate first encryption key information about the first encryption key, a package key generator configured to generate a package key by encrypting the first encryption key using a second encryption key and package key information about the package key, and a memory configured to store the first encryption key information, the package key, and the package key information.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a flowchart illustrating a method of protecting a broadcasting program in accordance with an embodiment of the present invention.

FIG. 2 is a diagram illustrating a system of protecting a broadcasting program in accordance with an embodiment of the present invention.

FIG. 3 illustrates a code that shows a box structure for storing package key information in accordance with an embodiment of the present invention.

FIG. 4 illustrates a code that shows a box structure for storing encryption key information in accordance with an embodiment of the present invention.

FIG. 5 illustrates a box structure of a sample entry when package key information and encryption key information are stored in a sample entry of a key message track in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

As described above, protection of a broadcasting program includes encryption of a broadcasting program. According to an embodiment of the present invention, a first encryption key used for encrypting a broadcasting program is encrypted again using a second encryption key. In the specification, the first encryption key, which is used for encrypting the broadcasting program and encrypted by the second encryption key, is defined as a package key.

In order to decrypt an encrypted broadcasting program by a first encryption key, a user or a terminal needs information about the first encryption key that is used to encrypt a broadcasting program and information about the encrypted first encryption key, which is the package key, that is encrypted by the second encryption key.

That is, in order to decrypt the encrypted broadcasting program, the encrypted first encryption key is decrypted using information about the package key and then the encrypted broadcasting program is decrypted using information about the first encryption key and the decrypted first encryption key. Therefore, the protection of the broadcasting program according to an embodiment of the present invention includes encryption of a broadcasting program, information about the first encryption key, generation of a package key which is encryption of the first encryption key using the second encryption key, and information about the package key. It is possible to decrypt the broadcasting program encrypted by the above information and to obtain comparability with various types of terminals.

Hereafter, a method and system for protecting a broadcasting program according to an embodiment of the present invention will be described with a terrestrial DTV broadcasting program. However, the present invention is not limited thereto. The present invention can be applied to various types of broadcasting programs such as cable broadcasting programs, satellite broadcasting programs, digital multimedia broadcasting programs, and IPTV broadcasting programs.

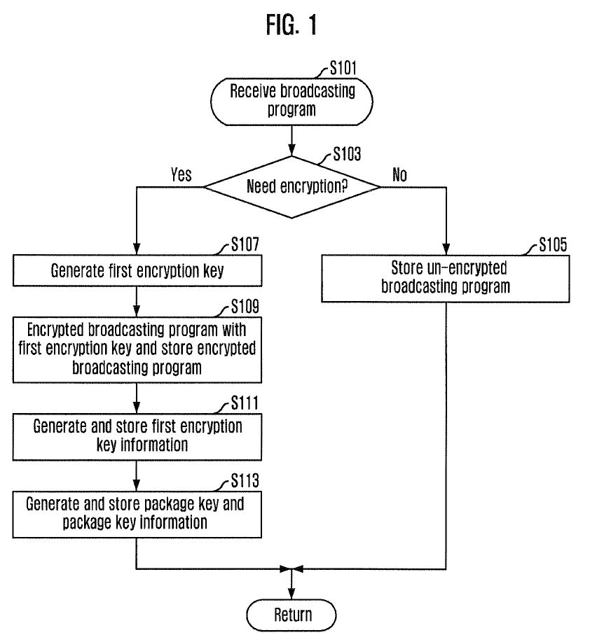

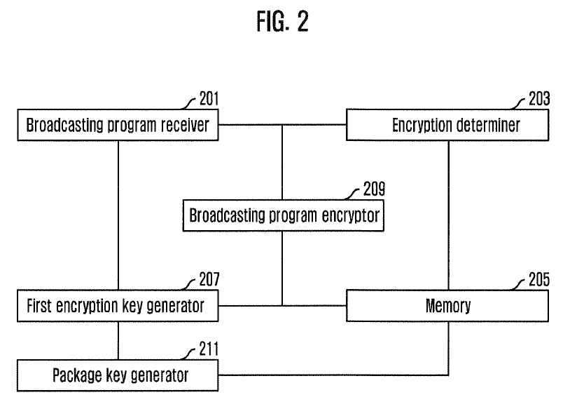

FIG. 1 is a flowchart of a method of protecting a broadcasting program in accordance with an embodiment of the present invention. FIG. 2 is a diagram illustrating a system of protecting a broadcasting program in accordance with an embodiment of the present invention.

As shown in FIG. 2, the system of protecting a broadcasting program according to the present invention includes a broadcasting program receiver 201, an encryption determiner 203, a memory 205, a first encryption key generator 207, a broadcasting program encryptor 209, and a package key generator 211. FIG. 1 is a flowchart describing operation of the system shown in FIG. 2. That is, FIG. 1 shows storing a broadcasting program protected through encryption.

In the method of protecting a broadcasting program according to an embodiment of the present invention, the broadcasting program receiver 201 receives a broadcasting program at step S101. At step 103, the encryption determiner 203 determines whether it is required to protect the received broadcasting program from distribution or it is free to distribute the received broadcasting program without encryption. Whether encryption is required or not may be decided in various ways according to a policy of a broadcasting program provider. For example, all of broadcasting programs can be encrypted according to the policy of the broadcasting program provider or information about the encryption of the broadcasting program can be inserted into the broadcasting program. In case of the terrestrial DTV broadcasting, PPI may be inserted into a broadcasting program. In this case, the encryption determiner 203 may use the PPI inserted in the broadcasting program to determine whether it is required to encrypt the received broadcasting program or not.

When the encryption determiner 203 determines that it is free to distribute the received broadcasting program without encryption at step S103, the received broadcasting program is stored in the memory 205 at step S105.

On the contrary, when the encryption determiner 203 determines that it is required to protect the received broadcasting program through encryption at step S103, the first encryption key generator 207 generates a first encryption key for encrypting the received broadcasting program from the broadcasting program receiver 201 at step S107. In generally, the first encryption key is independently provided from a broadcasting program. The first encryption key may be generated with well-known methods.

Then, the broadcasting program encryptor 209 encrypts the received broadcasting program from the broadcasting program receiver 201 based on the generated first encryption key from the first encryption key generator 207 and stores the encryted broadcasting program in the memory 205 at step S109.

The broadcasting program encryptor 209 generates first encryption key information and stores the generated first encryption key information in the memory 205 at step S111. The first encryption key information is information about how the broadcasting program is encrypted.

The first encryption key information is necessary information to decrypt the encrypted broadcasting program. Table 2 shows definition of the first encryption key information according to an embodiment of the present invention.

TABLE 2

| Field | Value |
|---|---|
| encryption_type | Information about encryption algorithm used |
| | for encrypting a broadcasting program. It |
| | indicates one of well-known algorithms such |
| | as Advanced Encryption Standard (AES), |
| | 3Data Encryption Standard (3DES), and |
| | Digital Video Broadcasting-Common |
| | Scrambling Algorithm (DVB-CSA). |
| key_length | Length of a first encryption key |
| mode | Encryption operation mode. It indicates |
| | one of well-known encryption modes such as |
| | Cipher Block Chaining (CBC), Reverse |
| | Chipher Block Chaining (RCBC), and |
| | Electronic Code Book (ECB). |

Referring to FIGS. 1 and 2 again, the package key generator 211 generates a package key by encrypting the first encryption key using a second encryption key and stores the encrypted first encryption key in the memory 205 at step S113.

In an embodiment, the first encryption key is encrypted using a domain key or an authentication key of a terminal that is authenticated to use a corresponding broadcasting program. The domain key is a key shared by users or terminals within a personal use/duplication range. Herein, the personal use/duplication range is a range of allowing a related user to legally duplicate, distribute, and/or use a corresponding broadcasting program. A technical term of the personal use/duplication range is a domain. The domain means a set of users or terminals that are allowed to store, distribute, and/or reproduce a broadcasting program. That is, the domain is generated through a technical process such as registration and authentication of a user or a terminal. The domain is also a technically controllable personal range of using or duplicating a broadcasting program. In the present embodiment, the domain key is defined as a key shared by users or terminals within the personal use/duplication range. Users or terminals in a domain are always changed due to joining and disjoining. Accordingly, the domain key is always changed.

When the first encryption key is encrypted using the domain key, it guarantees using a broadcasting program within a domain. On the contrary, it may restrict a terminal or a user from using a broadcasting program in the outside of the domain. That is, when the first encryption key is encrypted using the domain key or the terminal authentication key, it is possible to guarantee using a broadcasting program within the personal use/duplication range and to restrict illegal distribution.

The package key generator 211 generates a package key by encrypting the first encryption key using the domain key or the terminal authentication key as the second encryption key and stores the generated package key in the memory 205.

Meanwhile, the package key generator 211 generates package key information and stores the generated package key information in the memory 205 at step S113. Here, the package key information is about how the first encryption key is encrypted.

The package key information is information necessary for decrypting the encrypted first encryption key, that is, the package key. Table 3 shows definitions of the package key information according to an embodiment of the present invention.

TABLE 3

| Field | Value |
|---|---|
| principle_ID | It indicates domain ID or terminal ID. |
| | It indicates a domain ID when a second |
| | encryption key used to generate a package |
| | key is a domain key. It indicates a |
| | terminal ID when the second encryption key |
| | is a terminal authentication key. |
| key_type | It indicates a type of a second encryption |
| | key, that is, one of a domain key and a |
| | terminal authentication key. |
| encryption_type | It indicates an encryption algorithm used |
| | to generate a package key. It denotes one |
| | of well-known encryption algorithms such as |
| | Advanced Encryption Standard (AES), 3Data |
| | Encryption Standard (3DES), and Rivest, |
| | Shamir, Adleman (RSA). |
| key_length | Length of a second encryption key |
| padding_type | It indicates a padding method used to |
| | generate a package key. For example, it |
| | indicates one of padding methods such as no |
| | padding, zero padding, Public-Key |
| | Cryptography System (PKCS) padding, and |
| | Cipher Text Stealing (CTS) padding. |

In the present embodiment, a package key, package key information, and encryption key information may be stored in one file format or stored in different file formats.

The package key information and the encryption key information may be stored in a binary format, a text formation, or an XML formation.

A standard format for storing a broadcasting program includes an ISO Base Media File Format and a Digital Video Broadcasting File Format (DVB-FF). Since the ISO Base Media File Format and the DVB-FF are Open standard that have been well-known to those skilled in the art, detail description thereof is omitted. According to the standard format, audio and video of a broadcasting program are stored independently from metadata. The metadata is formed in a box unit.

As an embodiment of the present invention applied to the ISO Base Media File Format and the DVB-FF, a broadcasting program may be stored in a MPEG-2 TS Reception Hint Track, a package key may be stored in a Key Message Track, and package key information and first encryption key information may be stored in a Sample Entry of a Key Message Track. In this embodiment, terminals, users, and authenticated terminals in a domain can advantageously share one broadcasting program by storing multiple package keys together, such as a package key generated by encrypting the first encryption key using a domain key (second encryption key) and another package key generated by encrypting the first encryption key using a terminal authentication key (second encryption key). In case of one package key, the package key information and the first encryption key information may be stored in a Sample Entry of MPEG-2 TS Reception Hint Track.

Herein, MPEG-2 TS Reception Hint Track, Key Message Track and Sample Entry are defined in the ISO Base Media File Format and the DVB-FF. Since they are well-known to those skilled in the art, detail description thereof is omitted.

In the embodiment of the present invention, a box is defined for storing package key information and first encryption key information in order to apply the present embodiment into the ISO Base Media File Format and the DVB-FF.

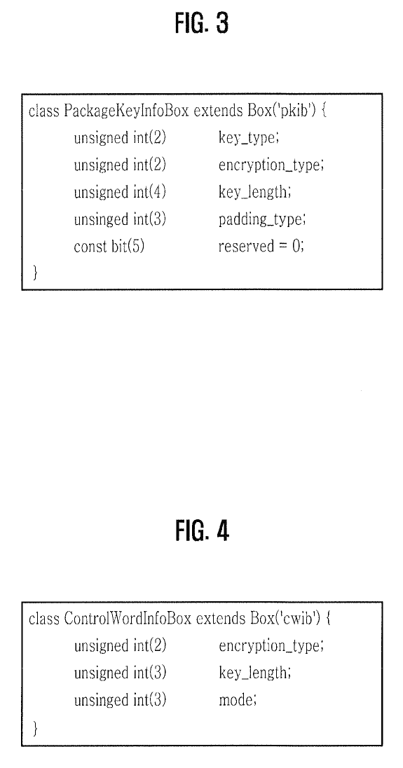

FIG. 3 illustrates a code showing a box structure for storing package key information in accordance with an embodiment of the present invention. Table 3 shows definitions of fields in FIG. 3.

FIG. 4 illustrates a code showing a box structure for storing encryption key information in accordance with an embodiment of the present invention. Table 2 shows definitions of fields shown in FIG. 4.

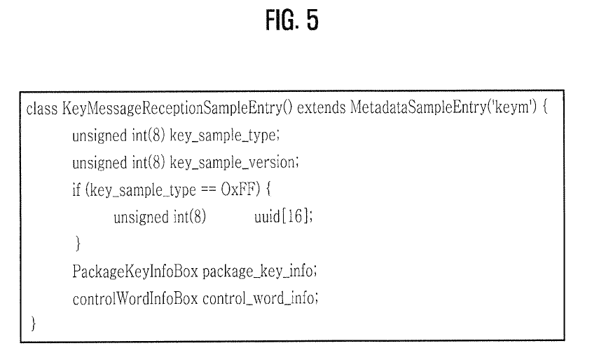

FIG. 5 illustrates a code showing a box structure of Sample Entry when package key information and encryption key information are stored in Sample Entry of Key Message Track in accordance with an embodiment of the present invention. FIG. 5 shows a code modified from a Sample Entry box structure defined in DVB-FF. Table 4 defines package key information and encryption key information shown in FIG. 5 in accordance with an embodiment of the present invention.

TABLE 4

| Field | Value |
|---|---|
| key_sample_type | It is a field defined in DVB-FF. It |
| | indicates a type of an encryption key. |
| | It has a value of 0xFF according to an |
| | embodiment of the present invention. |
| key_sample_version | It is a field defined in DVB-FF. It |
| | indicates a version of a first |
| | encryption key. It has a value of oxo1 |
| | according to an embodiment of the |
| | present invention. |
| uuid | It is an ID according to a type of a |
| | second encryption key. It indicates one |
| | of a domain ID or a terminal ID. It |
| | indicates a domain ID when a second |
| | encryption key used to generate a |
| | package key is a domain key. It |
| | indicates a terminal when the second |
| | encryption key is a terminal |
| | authentication key. |
| package_key_info | It indicates package key information. |
| | For example, it is package key |
| | information defined in FIG. 3. |
| control_word_info | It indicates first encryption key |
| | information. For example, it is |
| | encryption key information defined in |
| | FIG. 4. |

The box structure for storing package key information and encryption key information shown in FIGS. 3 and 4 may be used not only in Sample Entry of Key Message Track shown in FIG. 5 but also in various other locations except Sample Entry of MPEG-2 TS Reception Hint Track.

As described above, the present invention relates to a method and system for storing encryption key information and package key information for decrypting encrypted broadcasting programs to store broadcasting programs as a technology for protecting a broadcasting program.

The method and system according to the present invention store a broadcasting program encrypted by a first encryption key, information about the first encryption key, the encrypted first encryption key, which is the package key, encrypted by a second encryption key, and information about the package key in a terminal. Therefore, it is possible to decrypt and reproduce the broadcasting program encrypted based on the above information and to secure comparability with various types of terminals.

The method of the present invention described above may be programmed for a computer. Codes and code segments constituting the computer program may be easily inferred by a computer programmer of ordinary skill in the art to which the present invention pertains. The computer program may be stored in a computer-readable recording medium, i.e., data storage, and it may be read and executed by a computer to realize the method of the present invention. The recording medium includes all types of computer-readable recording media, that is it includes not only tangible media such as CD and DVD, but also intangible media such as carrier wave.

While the present invention has been described with respect to the specific embodiments, it will be apparent to those skilled in the art that various changes and modifications may be made without departing from the spirit and scope of the invention as defined in the following claims.

What is claimed is:

1. A method of protecting a broadcasting program, comprising:
generating and storing information about a first encryption key for encrypting the broadcasting program; and
generating package key information by encrypting the first encryption key using a second encryption key.

2. The method of claim 1, further comprising:
storing the broadcasting program encrypted by the first encryption key.

3. The method of claim 1, wherein the first encryption key information includes:
encryption algorithm information indicating an encryption algorithm used to encrypt the broadcasting program;
encryption operating mode information indicating an encryption operating mode used to encrypt the broadcasting program; and
length information indicating a length of the first encryption key.

4. The method of claim 1, wherein the package key information includes:
type information indicating a type of the second encryption key;
length information indicating a length of the second encryption key;
encryption algorithm information indicating an encryption algorithm used to generate the package key; and
padding information indicating a padding method used to generate the package key.

5. The method of claim 1, wherein the first encryption key information and the package key information are stored in a binary format.

6. The method of claim 1, wherein the first encryption key information and the package key information are stored in a text format.

7. The method of claim 1, wherein the first encryption key information and the package key information are stored in an XML format.

8. The method of claim 1, wherein the first encryption key and the package key information are stored in an ISO Base Media File Format.

9. The method of claim 8, wherein the first encryption key information and the package key information are defined in different box units as metadata.

10. The method of claim 8, wherein the first encryption key information and the package key information are defined in one box unit as metadata.

11. A system of protecting a broadcasting program, comprising:
a first encryption key generator configured to generate a first encryption key for encrypting the broadcasting program;
a broadcasting program encryptor configured to generate first encryption key information about the first encryption key;
a package key generator configured to generate a package key by encrypting the first encryption key using a second encryption key and package key information about the package key; and
a memory configured to store the first encryption key information, the package key, and the package key information.

12. The system of claim 11, wherein the broadcasting program encryptor encrypts the broadcasting program by the first encryption key, and the memory stores the broadcasting program encrypted by the first encryption key.

13. The system of claim 11, wherein the first encryption key information includes:
encryption algorithm information indicating an encryption algorithm used to encrypt the broadcasting program;
encryption operating mode information indicating an encryption operating mode used to encrypt the broadcasting program; and
length information indicating a length of the first encryption key.

14. The system claim 11, wherein the package key information includes:
type information indicating a type of the second encryption key;
length information indicating a length of the second encryption key;
encryption algorithm information indicating an encryption algorithm used to generate the package key; and
padding information indicating a padding method used to generate the package key.

15. The system of claim 11, wherein the first encryption key information and the package key information are stored in a binary format.

16. The system of claim 11, wherein the first encryption key information and the package key information are stored in a text format.

17. The system of claim 11, wherein the first encryption key information and the package key information are stored in an XML format.

18. The system of claim 11, wherein the first encryption key and the package key information are stored in an ISO Base Media File Format.

19. The system of claim 18, wherein the first encryption key information and the package key information are defined in different box units as metadata.

20. The system of claim 18, wherein the first encryption key information and the package key information are defined in one box unit as metadata.
